(19) United States
(12) Patent Application Publication
(10) Pub. No.: US 2024/0241740 A1
(43) Pub. Date: Jul. 18, 2024

(54) CLUSTER AFFINITY OF VIRTUAL MACHINES

(71) Applicant: VMware, Inc., Palo Alto, CA (US)

(72) Inventors: Alkesh Shah, Sunnyvale, CA (US); Deepak Babarjung, Palo Alto, CA (US); Swapnil Dattatraya Tiwari, Santa Clara, CA (US); Avinash Nagalapur Jambana Goud, Santa Clara, CA (US); Snigdha Gulhati, Palo Alto, CA (US); Gabriel Tarasuk-Levin, San Francisco, CA (US)

(73) Assignee: VMware, Inc., Palo Alto, CA (US)

(21) Appl. No.: 18/096,904

(22) Filed: Jan. 13, 2023

(51) Int. Cl. G06F 9/455

(52) U.S. Cl. CPC G06F 9/45558; G06F 2009/4557; G06F 2009/45575; G06F 2009/45591

(57) ABSTRACT

The disclosure provides a method for tracking virtual machines (VMs) associated with a plurality of hosts in an inventory. The method generally includes determining to remove a first host of the plurality of hosts, the first host running a first VM, wherein: the first host and a second host are associated with a first host cluster in the inventory; the first host is the associated-host and the registered-host of the first VM in the inventory; determining the first VM is associated with first host cluster based on the associated-host of the first VM being the first host and the first host being associated with the first host cluster; identifying the second host is associated with the first host cluster in the inventory; altering the associated-host of the first VM to the second host and unsetting the registered-host for the first VM in the inventory; and removing the first host.

### BACKGROUND

Virtualization is a process whereby software is used to create an abstraction layer over computer hardware that allows the hardware elements of a single computer to be divided into multiple virtual computers, such as virtual machines (VMs) or other types of virtual computing instances (VCIs). The software used is called a hypervisor—a small layer that enables multiple operating systems (OSs) to run alongside each other, sharing the same physical computing resources. When a hypervisor is used on a physical server (also known as a bare metal server or a host), the hypervisor enables the creation and management of virtual machines (VMs). The result is that each VM contains a guest OS, virtualized hardware that the OS requires to run, and one or more application(s) and their associated libraries and dependencies. Other types of virtual computing instances (VCIs) may also be used similarly as VMs.

VMs are frequently employed in data centers, cloud computing platforms, and/or other distributed computing systems, and are executed on the physical hosts of such systems. In some cases, these hosts may be logically grouped or “clustered” together as a single logical construct. Thus, the aggregated computing and memory resources of the cluster that are available for running VMs can be provisioned flexibly and dynamically to the various VMs being executed.

A virtualization manager may be used to manage each of the clusters of hosts, (e.g., having VMs running thereon) in the computing system. For example, the virtualization manager may be configured to carry out administrative tasks for the computing system, including managing the hosts, grouping the hosts into one or more host clusters, managing (e.g., configuring, starting, stopping, suspending, etc.) the VMs running within each host, provisioning the VMs, transferring the VMs from one host to another host, transferring application instances between the VMs, and/or and load balancing the VMs among the hosts within each host cluster. As such, the virtualization manager may provide disaster recovery, high-availability, resource pooling, clustering, and/or similar functionality among VMs, hosts, and host clusters in the computing system. The virtualization manager may be a computer program that resides and executes in a central server, which may reside in the computer system, or alternatively, may run as a VM in one of the hosts. One example of a virtualization manager is the vCenter Server® product made commercially available by VMware, Inc. of Palo Alto, California.

To provide such functionality, the virtualization manager may maintain an inventory of objects. The objects may be either containers of other objects, such as folders, or objects that are managed by the virtualization manager, including data centers, clusters, hosts, VMs, templates, networks, and/or resource pools. In other words, the inventory is a hierarchical collection of virtual and physical objects organized in a meaningful way to provide a structure over which different permissions may be granted, different tasks and and/or events may be monitored, different alarms may be set, and/or the like. The topmost element of the inventory hierarchy is known as the “Root Object,” which is nothing more than the virtualization manager itself. Data center objects representing data centers managed by the virtualization manager may be below the Root Object in the hierarchy, and each data center object may have its own set of cluster objects. Each cluster object may include one or more host objects, and each host object may include one or more VM objects in the hierarchy. Thus, the inventory may maintain host-cluster relationships for each cluster, and VM-host relationships for each host in each cluster identified in the inventory. Thus, each host object may have an association with a cluster object identified in the inventory. Further, because each host object can include one or more VM objects (and VM-host relationships are managed in the cluster), each VM object may also have an association with a cluster object associated with its corresponding host object.

As described above, in some cases, the virtualization manager may be responsible for host management, which may include monitoring a state of each host within each cluster managed by the virtualization manager. By monitoring the state of each of the hosts, the virtualization manager may detect when a host has become unresponsive and/or has failed. The virtualization manager may be responsible for removing a failed host from a cluster and, in some cases, replacing the failed host with a new host to maintain capacity in the cluster. Cluster capacity is defined by the sum of compute resources (e.g., central processing unit (CPU), memory, disk space, etc.) of all the hosts in the cluster. Removal of the failed host may consist of physically removing the failed host from the cluster and data center, suspending all monitoring activities the virtualization manager performs for that host, and removing the host object (e.g., corresponding to the failed host) from the virtualization manager inventory. Removal of the host object from inventory may cause VM objects, associated with that host object (e.g., via VM-host relationships maintained in inventory), to also be removed from inventory. In other words, altering the association between the host and its corresponding cluster in inventory such that the particular host-cluster relationship is removed may also cause such VMs' associations with the cluster to be altered. This alternation may result in VM objects (e.g., associated with the host object) being removed from inventory.

Disappearance of VM objects from the virtualization manager inventory due to the removal of host objects may be undesirable from a customer's perspective. For example, a customer may expect their applications, particularly with respect to mission-critical applications, running on VMs in a cluster to be continuously available. The customer may be indifferent to where these VMs, running their applications, are deployed (e.g., which host each VM is running on), as long as such VMs are always accounted for and running (e.g., with minimal or no downtime) within the cluster. As such, when a host, where multiple VMs are deployed, fails, the customer may only care that these VMs remain in the cluster and continue operations, irrespective of which new host(s) the VMs are recovered on. However, where removal of the failed host results in removal of a host object for the failed host maintained in inventory, and in conjunction a VM object for each of the VMs maintained in inventory, the VMs may no longer be accounted for in the cluster.

Additionally, it may be operationally complex to recover such VMs. For example, recovery may require (1) identification of all the VMs that were present on the host prior to the host being removed form cluster and inventory, (2) re-registration of each of these VMs, and (3) taking appropriate actions to power these VMs on one or more hosts in the cluster.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for tracking virtual machines (VMs) associated with a plurality of hosts in an inventory. The method generally includes determining to remove a first host of the plurality of hosts, where the first host is running a first VM. The first host and a second host are associated with a first host cluster in the inventory. The first host is identified as the associated-host of the first VM in the inventory. Additionally, the first host is identified as the registered-host of the first VM in the inventory. The method further includes determining the first VM is associated with first host cluster based on the associated-host of the first VM being the first host and the first host being associated with the first host cluster. The method further includes identifying the second host is associated with the first host cluster in the inventory. The method further includes altering the associated-host of the first VM such that the second host is the associated-host of the first VM in the inventory. The method further includes unsetting the registered-host for the first VM such that the first VM is not registered with any of the plurality of hosts in the inventory. The method further includes removing the first host.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates an example networking environment in which embodiments described herein may be implemented.

FIG. 2A illustrates example host-cluster and virtual machine (VM)-host relationships maintained in inventory by a virtualization manager, according to an example embodiment of the present application.

FIG. 2B illustrates the removal of a host from an existing host cluster, according to an example embodiment of the present application.

FIG. 3A illustrates example VM-cluster relationships maintained in inventory by the virtualization manager, according to an example embodiment of the present application.

FIG. 3B illustrates maintenance of a VM-cluster relationship when a host is removed from the cluster, according to an example embodiment of the present application.

FIG. 4 is a flow diagram illustrating example operations for maintaining VM-cluster relationships, according to an example embodiment of the present application.

FIG. 5 is a call flow diagram illustrating example operations for recovering orphaned VMs, according to an example embodiment of the present application.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for maintaining cluster affinity of virtual machine (VMs) running on hosts in a cluster are described herein. More specifically, techniques described herein help to ensure that VM-cluster relationships between VM objects and a cluster object maintained in a virtualization manager inventory (e.g., maintained by a virtualization manager managing VMs and the cluster corresponding to these objects) are not impacted when host-cluster relationships between host objects and the cluster object maintained in the inventory are altered. A host-cluster relationship between a host object and a cluster object maintained in the inventory may be altered where hosts (e.g., corresponding to the host objects) are removed from and/or added to a cluster (e.g., corresponding to the cluster object) managed by the virtualization manager.

For example, a VM may be running on a first host in a host cluster. The host cluster may include the first host and a second host. The VM, the first host, the second host, and the host cluster may be managed by a virtualization manager. In particular, the virtualization manager may maintain an inventory having a VM object corresponding to the VM, a first host object corresponding to the first host, a second host object corresponding to the second host, and a cluster object corresponding to the cluster object. There may be a direct relationship between the cluster object and the first host object (e.g., a host-cluster relationship), a direct relationship between the cluster object and the second host object, and a direct relationship between the first host object and the VM object (e.g., a VM-host relationship). The relationship between the first host object and the VM object may indicate that the first host, corresponding to the first host object, is the associated-host of the VM. As used herein, the associated-host may be a host that the virtualization manager understands the VM to be associated or correlated with. The associated-host may be used to derive the cluster where the VM is present in inventory. The cluster derived for the VM may be the cluster associated with the VM and may indicate a VM-cluster relationship that the virtualization manager is to maintain for the VM in inventory.

The VM may also have a registered-host, where the registered-host is the physical host where the VM is running and registered with (e.g., a pointer to host level services for the VM). For a VM that is powered on and running, both the associated-host and the registered-host may be the same host (which is true for this example). In some cases, the associated-host or the registered-host for a VM may be different where one of the associated-host or the registered-host is in a transient state. Further, in some cases, a VM may not be registered with any host; thus, the registered-host for the VM may be unset. A VM that is not registered with any host, but has an associated-host identified in the inventory, may be referred to herein as an “orphaned VM.”

For this example, it may be assumed that the first host running the VM fails. The virtualization manager may detect this failure based on monitoring the state of the first host and, in response, take action to remove the first host from the cluster. However, prior to removing the first host from the cluster, the virtualization manager may determine which cluster the VM is present within (e.g., associated with) in the inventory. As described above, the virtualization manager may make this determination based on the associated host (e.g., the first host) of the VM. After determining the cluster associated with the VM, the virtualization manager may alter the associated-host of the VM in the inventory such that the VM is no longer associated with the first host (e.g., failed host) and is instead associated with another host of the determined host cluster (e.g., selected at random), for example, the second host. To alter the associated-host of the VM, the virtualization manager may alter a mapping of the VM object to the first host object such that the VM object is no longer mapped to the first host object and is instead mapped to the second host object in the inventory. By making this alteration, the VM-cluster relationship may be maintained in inventory, even where the first host object is removed as a result of detecting that the first host has failed and needs to be removed.

In addition to altering the associated-host of the VM maintained in the inventory, the registered-host of the VM may be unset. Unsetting the registered host of the VM may indicate that the VM is no longer registered on the first host such that the first host is able to be removed from the cluster. The VM may be considered an orphaned VM when the registered host for the VM is unset.

After altering both the associated-host and the registered-host, the failed, first host may be removed from the host cluster, and the first host object for the first host may be removed from the inventory. Because the associated-host of the VM was previously altered, removing the first host object may not impact the VM object corresponding to VM in inventory. As such, the VM may continue to be accounted for in inventory, and the VM-cluster relationship may be maintained.

In certain embodiments, high availability may be provided for applications running on VMs in the cluster managed by the virtualization manager. High availability is a characteristic of a component or system that is capable of operating continuously without failing. In particular, in the example provided above, after altering the associated-host and the registered-host of the VM, the VM may be in an orphaned state (e.g., a VM that exists in the virtualization manager inventory but is not registered/present on any host). To allow the previously-running VM to continue operations, a high availability module may be used to bring up the VM when the module detects that the VM is no longer running on any host in the cluster. In other words, the high availability module may attempt to recover the VM by powering on the VM on another host in the cluster. After successfully powering on the VM, the state of the VM may match a state of the VM prior to removal of the first host (e.g., in a powered on state).

The techniques described herein help to maintain cluster affinity of virtual VMs such that information about VMs is not lost as part of host removal workflows. Further, techniques described herein help to ensure high availability for VMs, especially for VMs where critical applications are running, when a host that the VM was originally associated with is removed.

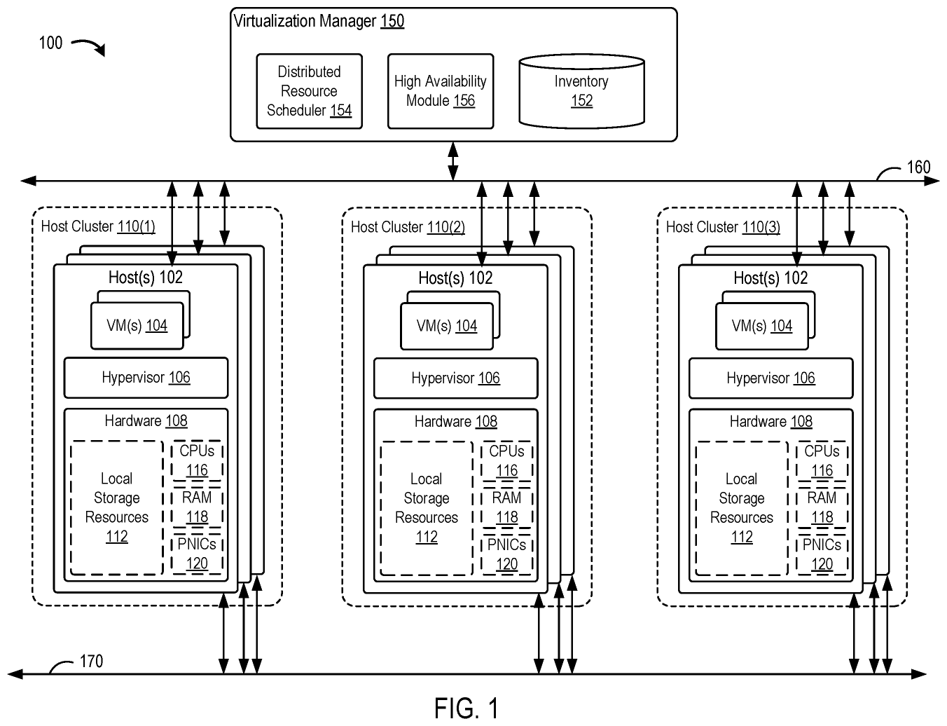

FIG. 1 is a block diagram that illustrates a virtual environment 100 in which embodiments described herein may be implemented. Virtual environment 100 includes one or more host clusters 110 having one or more hosts 102, a management network 160, a data network 170, and a virtualization manager 150. Data network 170 and management network 160 may be implemented as separate physical networks or as separate virtual local area networks (VLANs) on the same physical network.

Host(s) 102 may be communicatively connected to data network 170 and management network 160. Data network 170 and management network 160 are also referred to as physical or “underlay” networks, and may be separate physical networks or the same physical network as discussed. As used herein, the term “underlay” may be synonymous with “physical” and refers to physical components of virtual environment 100. As used herein, the term “overlay” may be used synonymously with “logical” and refers to the logical network implemented at least partially within virtual environment 100.

Host(s) 102 may be geographically co-located servers on the same rack or on different racks in any arbitrary location in one or more data centers. Host(s) 102 may be in a single host cluster 110 or logically divided into a plurality of host clusters 110. For example, as shown, hosts 102 may be logically divided into host cluster 110(1), host cluster 110(2), and host cluster 110(3).

Host(s) 102 may be configured to provide a virtualization layer, also referred to as a hypervisor 106, that abstracts processor, memory, storage, and networking resources of a hardware platform 108 into multiple VMs 104. Each VM 104 may implement a virtual hardware platform that supports the installation of a guest OS which is capable of executing one or more applications (not shown). An application may be any software program, such as a word processing program. The guest OS may be a standard, commodity operating system. Examples of a guest OS include Microsoft Windows, Linux, and the like.

Host(s) 102 may be constructed on a server grade hardware platform 108, such as an x86 architecture platform. Hardware platform 108 of a host 102 may include components of a computing device such as one or more processors (CPUs) 116, system memory (e.g., random access memory (RAM)) 118, one or more network interfaces (e.g., network interface cards (NICs) 120), local storage resources 112, and other components (not shown). A CPU 116 is configured to execute instructions, for example, executable instructions that perform one or more operations described herein and that may be stored in the memory and storage system. The network interface(s) enable host 102 to communicate with other devices via a physical network, such as management network 160 and data network 170.

Local storage resources 112 may be housed in or directly attached (hereinafter, use of the term “housed” or “housed in” may be used to encompass both housed in or otherwise directly attached) to hosts 102. Local storage resources 112 housed in or otherwise directly attached to the hosts 102 may include combinations of solid state drives (SSDs) or non-volatile memory express (NVMe) drives, magnetic disks (MD) or spinning disks, or slower/cheaper SSDs, or other types of storages. In certain embodiments, local storage resources 112 of hosts 102 may be leveraged to provide an aggregate object-based store to VMs 104 running on hosts 102. The distributed object-based store may be a virtual storage area network (VSAN).

In certain embodiments, virtualization manager 150 is a computer program that executes in a server in virtual environment 100, or alternatively, virtualization manager 150 runs in one of VMs 104. Virtualization manager 150 is configured to carry out administrative tasks for virtual environment 100, including managing hosts 102, managing (e.g., configuring, starting, stopping, suspending, etc.) VMs 104 running within each host 102, provisioning VMs 104, transferring VMs 104 from one host 102 to another host 102, transferring VMs 104 between data centers, transferring application instances between VMs 104 or between hosts 102, and load balancing VMs 104 among hosts 102 within each host cluster 110. Virtualization manager 150 takes commands as to creation, migration, and deletion decisions of hosts 102, VMs 104, and application instances in virtual environment 100. However, virtualization manager 150 also makes independent decisions on management of hosts 102, local VMs 104, and application instances. For example, virtualization manager 150 may make independent decisions regarding placement of VMs 104 and application instances between hosts 102.

In certain embodiments, virtualization manager 150 includes a distributed resource scheduler (DRS) 154. DRS 154 provides the ability to view and manage the resources of hosts 102 for each host cluster 110 in virtual environment 100. In certain embodiments, DRS 154 provides automatic initial VM 104 placement on any of the hosts 102, and also makes automatic resource relocation and optimization decisions as hosts 102 and/or VMs 104 are added and/or removed from virtual environment 100. DRS 154 can also be configured for manual control, in which case DRS 154 makes recommendations to a user or administrator who can review and carry out the changes manually.

In certain embodiments, virtualization manager 150 includes a high availability module 156. High availability module 156 is responsible for detecting VM 104 failures and orchestrating VM 104 failovers/restarts. For example, when high availability module 156 detects a failure that requires one or more VMs 104 to be failed-over/restarted, the high availability module 156 executes a failover workflow that involves (1) identifying an active host 102 (e.g., in a host cluster 110) for placing the VM 104 that can meet the VM's resource needs, and (2) initiating a VM 104 restart on the identified host 102. As such, high availability module 156 helps to ensure high availability of VMs 104 and applications running thereon. In certain embodiments, as described herein, high availability module 156 invokes the failover workflow as a result of determining a host 102, associated with the VM 104, has failed and/or has become unresponsive and thus needs to be removed.

In certain embodiments, to carry out administrative tasks for virtual environment 100, including managing host clusters 110, hosts 102, and VMs 104, providing distributed resource scheduling, and providing high availability, to name a few, virtualization manager 150 may maintain a virtualization manager inventory 152 (also referred to herein as “inventory 152”). As described above, inventory 152 is a hierarchical collection of virtual and physical objects organized in a meaningful way to provide a structure over which virtualization manager 150 may manage virtual and physical components (e.g., host clusters 110, hosts 102, VMs 104, etc.) in virtual environment 100. Virtual and physical objects in inventory 152 may represent host clusters 110, hosts 102, VMs 104, etc. managed by virtualization manager 150.

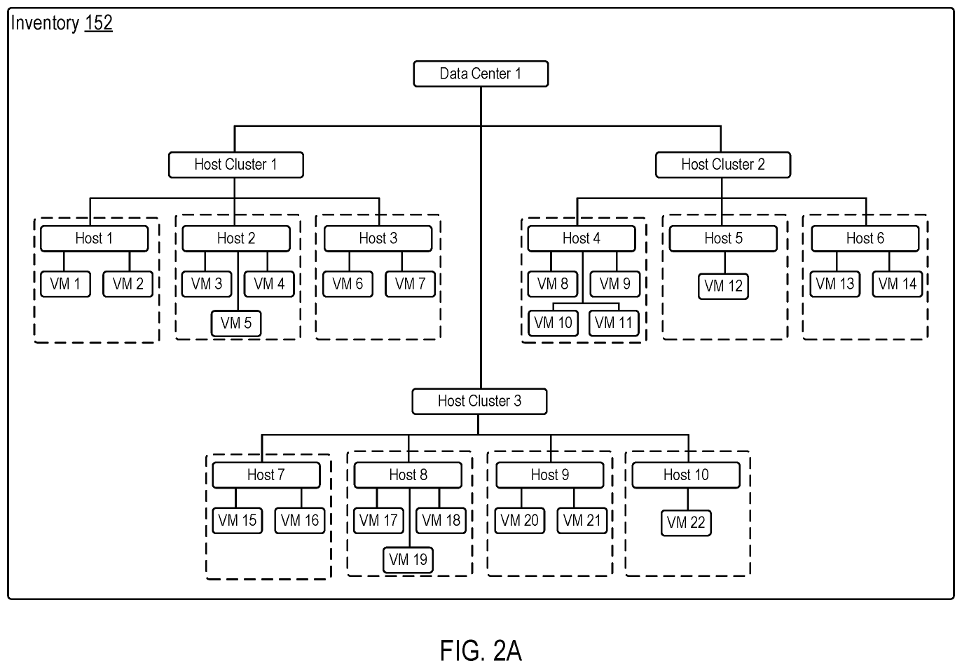

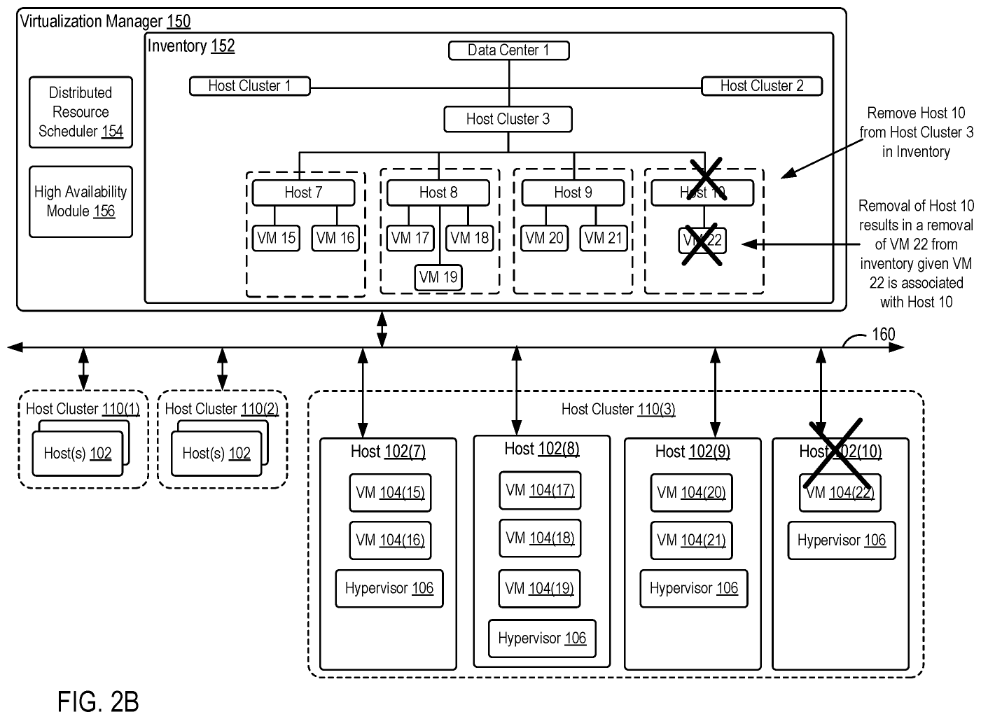

An example inventory 152 including objects for the three host clusters 110 (and their respective hosts 102 and VMs 104) illustrated in FIG. 1 is provided in FIG. 2A. For ease of explanation, and not meant to be limiting to this particular example, it may be assumed that virtualization manager 150 manages three host clusters 110 (e.g., host cluster 110(1) also referred to as “host cluster 1”, host cluster 110(2) also referred to as “host cluster 2,” and host cluster 110(3) also referred to as “host cluster 3”), as shown in FIG. 1, in a single data center. Host cluster 1 may include three hosts 102 (e.g., host 102(1), host 102(2), and host 102(3). Host 102(1) may include two VMs 104 (e.g., VM 104(1) and VM 104(2) running on host 102(1)), host 102(2) may include three VMs 104 (e.g., VM 104(3), VM 104(4), and VM 104(5)), and host 102(3) may include two VMs 104 (e.g., VM 104(6) and VM 104(7)). Additionally, host cluster 2 may include three hosts 102 (e.g., host 102(4), host 102(5), and host 102(6)). Host 102(4) may include four VMs 104 (e.g., VM 104(8), VM 104(9), VM 104(10), and VM 104(11)), host 102(5) may include one VM 104 (e.g., VM 104(12)), and host 102(6) may include two VMs 104 (e.g., VM 104(13) and VM 104(14)). Further, host cluster 110(3) may include four hosts 102 (e.g., host 102(7), host 102(8), host 102(9), and host 102(10)). Host 102(7) may include two VMs 104 (e.g., VM 104(15) and VM 104(16)), host 102(8) may include three VMs 104 (e.g., VM 104(17), VM 104(18), and VM 104(19)), host 102(9) may include two VMs 104 (e.g., VM 104(20) and VM 104(21)), and host 102(10) may include one VM 104 (e.g., VM 104(22)).

Each of these VMs 104(1)-(22) may be in a powered on state and running on each of their respective hosts 102. As such, a registered-host of each VM 104(1)-(22) may be the host 102 where the VM 104 is running. For example, the registered-host for VM 104(1) is host 102(1) given VM 104(1) is physically located on and registered with host 102(1). Further, for this example, an associated-host of each VM 104(1)-(22) may be the same as the registered-host corresponding to each VM 104. For example, the associated-host for VM 104(1) is host 102(1). As described above, the associated-host for a VM 104 may be a host 102 that virtualization manager 150 understands the VM 104 to be associated or correlated with.

Objects corresponding to each host cluster 110, host 102, and VM 104 are included in inventory 152 (e.g., the “VM 1” object corresponds to VM 104(1)). Inventory 152 may illustrate direct relationships between the cluster object corresponding to host cluster 110(1) and each host object corresponding to host 102(1), host 102(2), and host 102(3) (e.g., thereby indicating host-cluster relationships for these hosts and host cluster). Additionally, inventory 152 may illustrate direct relationships between each host object corresponding to host 102(1), host 102(2), and host 102(3) and VM objects of their respective VMs 104 (e.g., thereby indicating VM-host relationships for these VMs and hosts). Similar relationships may be maintained in inventory 152 for host cluster 110(2) and host cluster 110(3).

The relationship between each host object and VM object in inventory 152 may indicate an associated-host of the VM 104 corresponding to the VM object. For example, because the VM 1 object for VM 104(1) is shown in the hierarchy below the host 1 object for host 102(1), the associated-host for VM 104(1) is host 102(1). In other words, host 102(1) is the host which virtualization manager 150 understands VM 104(1) to be associated or correlated with.

Inventory 152 maintained by virtualization manager 150 may change over time. In certain embodiments, inventory 152 may change as a result of removing a host 102. A host 102 may be removed based on virtualization manager 150 receiving a request from a user to remove the host and/or based on virtualization manager 150 detecting that the host 102 has failed and/or has become unresponsive. Although not meant to be limiting to this particular example, in the example illustrated in FIG. 2A, it may be assumed that virtualization manager 150 detects a failure of host 102(10) based on monitoring a state of host 102(10) and, in response, takes action to remove host 102(10) from host cluster 110(3). Operations for the removal of host 102(10) from host cluster 110(3) are illustrated in FIG. 2B.

As illustrated in FIG. 2B, as part of removing host 102(10) from host cluster 110(3), virtualization manager 150 may also remove the host 10 object corresponding to host 102(10) from inventory 152. Removal of the host 10 object may remove the relationship between the host cluster 3 object and the host 10 object previously-maintained in inventory 152. Further, the removal of the host 10 object may undesirably remove the VM 22 object from inventory 152. In particular, although virtualization manager 150 determines that host 102(10) is to be removed, this does not mean that VM 104(22) is also to be removed from cluster 110(3) and/or from inventory 152. However, because of the associations maintained in inventory 152 between each host object and each VM object, the removal of the host 10 object may result in the removal of the VM 22 object that the customer does not desire to remove from inventory 152. Instead, the customer may prefer that VM 104(22), corresponding to the removed VM 22 object, continue to run in cluster 110(3) but on a different host 102 within cluster 110(3) when host 102(10) is removed. Further, the customer may prefer that the VM 22 object for VM 104(22) not be removed from inventory 152 such that virtualization manager 150 is able to continue tracking VM 104(22) and realize that VM 104(22) corresponding to this VM 22 object needs to restarted on another host 102 in cluster 110(3). However, by removing VM 22 object from inventory 152, virtualization manager 150 may have no recollection of VM 104(22), and as such, virtualization manager 150 may not know that this VM 104(22) is to be restarted on a different host 102 within host cluster 110(3).

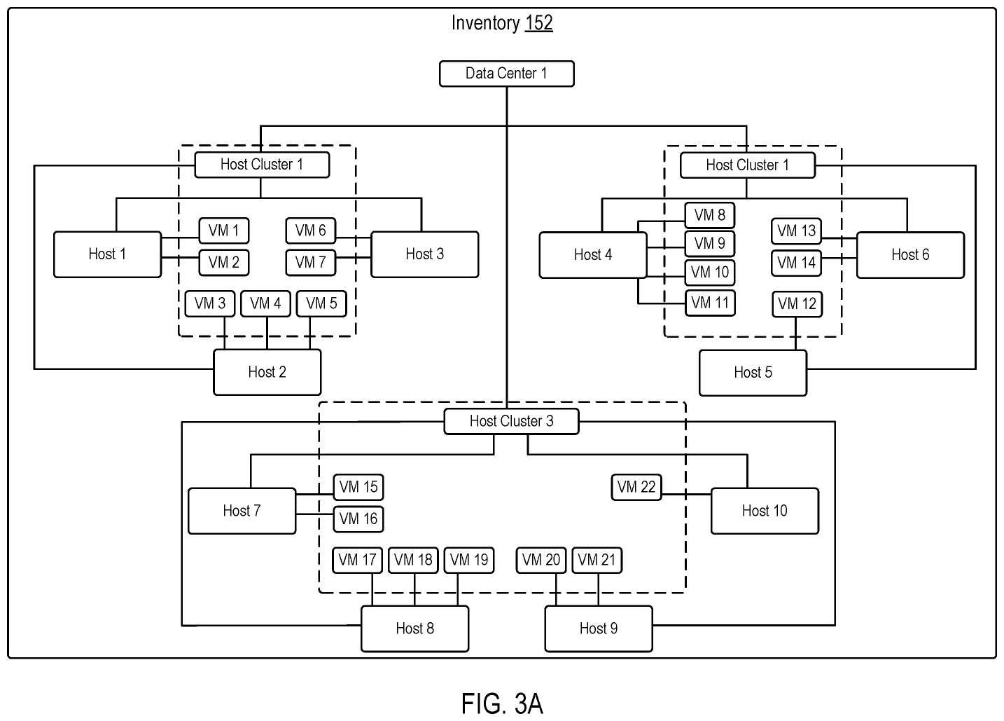

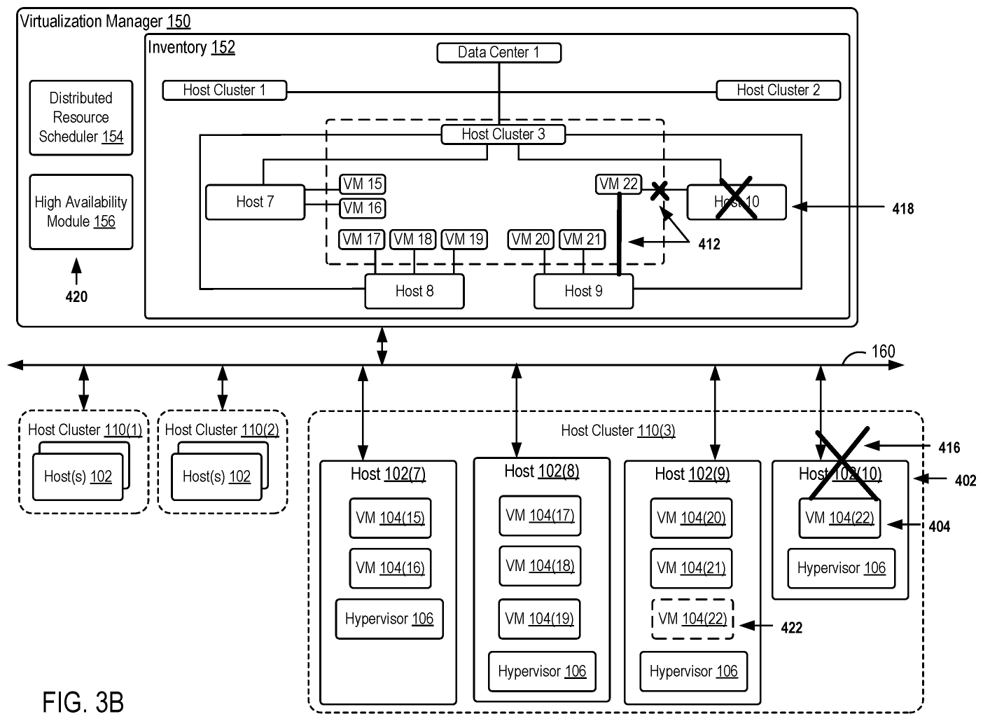

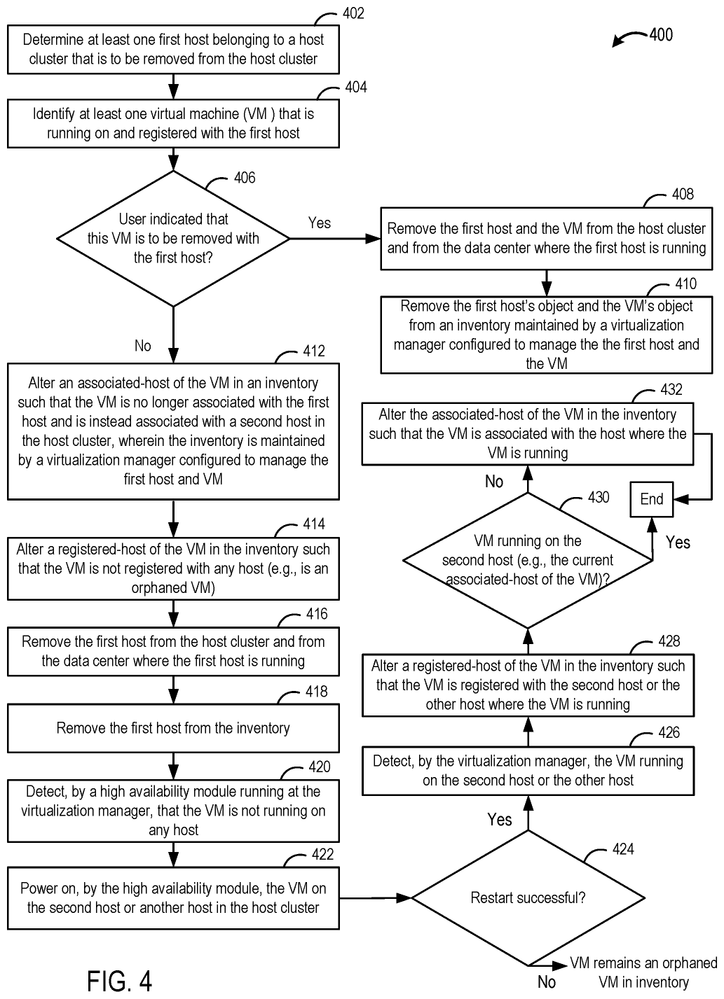

Thus, aspects described herein provide techniques for maintaining cluster affinity of VMs to help ensure that VM-cluster relationships between VM objects and a cluster object maintained in inventory 152 are not impacted when host-cluster relationships between host objects (associated with the VM objects) and the cluster object maintained in the inventory are altered. As described in detail below with respect to FIG. 3A, FIG. 3B, and FIG. 4, prior to removing a host object from inventory, virtualization manager 150 may determine which VM objects are associated with that host object. Virtualization manager 150 may determine a cluster object associated with each identified VM object and, based on the determined cluster object, select a host object (e.g., excluding the host object that is to be removed) that is also associated with the cluster object (e.g., corresponding to a host in the cluster). Virtualization manager 150 may re-associate each VM object with a selected host object associated with the cluster object. In particular, virtualization manager 150 may alter the association of each VM object such that the host object associated with each VM object is no longer the host object which is to be removed from inventory 152. Accordingly, the VM object may remain in inventory 152 when the host object is removed, and virtualization manager 150 may maintain the VM-cluster relationship originally established for each VM object in inventory 152.

FIG. 3A illustrates example VM-cluster relationships maintained in inventory 152 by virtualization manager 150, according to an example embodiment of the present application. Inventory 152 illustrated in FIG. 3A is similar to inventory 152 illustrated in FIG. 2A; however, in FIG. 3A, virtualization manager 150 is also aware of VM-cluster relationships between VM objects and cluster objects. For example, in addition to realizing the VM-host relationship between the VM 1 object and the host 1 object, virtualization manager 150 may also be aware of the VM 1 object's association with the host cluster 1 object. Virtualization manager 150 may determine this VM-cluster association based on the associated-host of the VM 1 object. For example, because the VM−1 object is associated with the host−1 object, and the host−1 object is associated with the host cluster 1 object, virtualization manager 150 may derive that the VM 1 object also corresponds to the host cluster 1 object. Virtualization manager 150 may determine a VM-cluster relationship for each VM object in inventory 152. As illustrated in FIG. 3B, this VM-relationship may be used, for example, when a host object associated with a VM object is to be removed from inventory 152.

FIG. 3B illustrates maintenance of a VM-cluster relationship when a host 102 is removed from a host cluster 110 (and its corresponding host object is removed from inventory), according to an example embodiment of the present application. The example host 102 removal illustrated in FIG. 3B may be described with respect to operations 400 illustrated in FIG. 4. In particular, FIG. 4 is a flow diagram illustrating example operations 400 for maintaining VM-cluster relationships, according to an example embodiment of the present application. Operations 400 may be performed by virtualization manager 150 illustrated in FIG. 1 and FIG. 3B.

Operations 400 begin, at operation 402, by determining at least one first host 102 belonging to a host cluster 110 that is to be removed from the host cluster 110. In particular, virtualization manager 150 may monitor the state of each host 102 managed by virtualization manager 150. In certain embodiments, based on the monitoring, virtualization manager 150 may determine that at least one host 102 has failed and/or has become unresponsive and needs to be removed. In certain other embodiments, virtualization manager 150 may be instructed (e.g., by a user) to remove a particular host 102. For the example illustrated in FIG. 3B, at operation 402, virtualization manager 150 may determine that host 102(10) is to be removed from host cluster 110(3) (and further from the data center where host cluster 110(3) is deployed).

Operations 400 proceed, at operation 404, by identifying at least one VM 104 that is running on and registered with the first host 102. For the example illustrated in FIG. 3B, at operation 404, virtualization manager 150 may determine that VM 104(22) is running on and registered with host 102(10). Although this example illustrates virtualization manager 150 identifying only one VM running on and registered with the host 102 that is to be removed, in some other embodiments, at operation 404, virtualization manager 150 may determine that two or more VMs are running on and registered with the host 102 that is to be removed.

Operations 400 proceed, at operation 406, by determining whether a user desires to remove the identified VM 104 from the first host 102 when the first host 102 is removed. Where at, operation 406, virtualization manager 150 determines that the VM 104 identified at operation 404 is to be removed (e.g., as indicated by a user), at operation 408, virtualization manager 150 removes the first host 102 and the VM 104 from the host cluster 110 and from the data center where the first host 102 is running. Further, at operation 410, virtualization manager 150 removes the first host 102's object and the VM 104's object from an inventory 152 maintained by a virtualization manager 150. Virtualization manager 150 may be configured to manage the first host 102 and the VM 104, as such an inventory 152 maintained by virtualization manager 150 may include objects corresponding to the first host 102 and VM 104.

Alternatively, where, at operation 406, virtualization manager 150 determines that the VM 104, identified at operation 404, is not to be removed with the host 102, at operation 412, virtualization manager 150 alters an associated-host of VM 104. Virtualization manager 150 may alter the associated-host of VM 104 such that VM 104 is no longer associated with the first host 102 and is instead associated with a second host 102 in the same host cluster 110 as the first host 102. More specifically, virtualization manager 150 may derive a cluster associated with VM 104 based on the current associated-host of VM 104. Virtualization manager 150 may identify which other hosts 102 belong to this cluster and associate the VM 104 with one of these other hosts 102.

For the example illustrated in FIG. 3B, at operation 412, virtualization manager 150 alters an associated-host of VM 104(22) in inventory 152. In particular, prior to operation 412, host 102(10) is associated with VM 104(22). This association is represented by the line between the VM 22 object and the host 10 object in inventory 152. To determine a new host association for VM 104(22), virtualization manager 150 may determine which host cluster VM 104(22) belongs to. Virtualization manager 150 may determine that VM 104(22) is associated with host cluster 110(3) based on the VM-host relationship between VM 104(22) and host 102(10) and the host-cluster relationship between host 102(10) and host cluster 110(3) maintained by virtualization manager 150 in inventory 152. Virtualization manager 150 may further determine that host cluster 110(3) includes host 102(7), host 102(8), and host 102(9) based on host-cluster relationships maintained in inventory 152 for each of these hosts 102. Accordingly, virtualization manager 150 may determine to associate VM 104(22) with either host 102(7), host 102(8), or host 102(9) such that the VM-cluster relationship between VM 104(22) and cluster 110(3) is maintained. In this example, virtualization manager 150 chooses host 102(9) and alters the associated-host of VM 104(22) accordingly. Altering the associated-host of VM 104(22) may include removing the association between the VM 22 object and the host 10 object in inventory 152 and adding an association between the VM 22 object and the host 9 object in inventory 152.

Operations 400 proceed, at operation 414, by altering a registered host of VM 104 in inventory 152 such that VM 104 is not registered with any host 102 (e.g., is an orphaned host). Further, at operation 416, virtualization manager 150 removes the first host 102 from the host cluster 110 and from the data center where the first host 102 is running. At operation 418, virtualization manager 150 removes the host object corresponding to the first host from inventory 152. For the example illustrated in FIG. 3B, operation 414 includes unsetting a registered-host of VM 104(22) to indicate that VM 104(22) is not currently registered or physically running on any host 102 managed by virtualization manager 150. Further, operations 416 and 418 include removing host 102(10) altogether and removing the object 10 object from inventory, respectively.

Operations 400 proceed, at operation 420, by a high availability module 156 running at virtualization manager 150, detecting that the VM 104 is not running on any host 102 managed by virtualization manager 150. For example, at operation 420 in FIG. 3B, virtualization manager 150 may detect that VM 104(22), identified by the VM 22 object in inventory 152, is not running on any host 102 managed by virtualization manager 150.

Accordingly, at operation 422, high availability module 156 may attempt to power on the VM 104 on the newly associated-host of VM 104 (e.g., the second host 102) or another host in the host cluster 110 (e.g., while continuing to maintain the VM-cluster relationship for VM 104). In FIG. 3B, at operation 422, high availability module 156 may attempt to power on VM 104(22) on host 102(9) (e.g., the new associated-host of VM 104 indicated in inventory 152). Although in this example, high availability module 156 attempts to restart VM 104(22) on host 102(9), in some other examples, high availability module 156 may attempt to restart VM 104(22) on host 102(7) or host 102(8), as both of these hosts 102 are within host cluster 110(3). In certain embodiments, high availability module 156 may determine which host 102 to restart VM 104 on based on a recommendation from DRS 154.

Operations 400 proceed, at operation 424, by determining whether the restart of VM 104 was successful. High availability module 156 may make this determination. Where, at operation 424, high availability module 156 determines that the restart of VM 104 was unsuccessful, VM 104 may remain in an orphaned state in inventory 152. On the other hand, where, at operation 424, high availability module 156 determines that the restart of VM 104 was successful, at operation 426, virtualization manager 150 may be able to detect that VM 104 is running, and more specifically, on which host 102, VM 104 has been successfully restarted. In the example illustrated in FIG. 3B, it may be assumed that the restart of VM 104(22) on host 102(9) was successful; thus, at operation 426, virtualization manager 150 may be able to detect that VM 104(22) is running on host 102(9).

Operations 400 proceed, at operation 428, by virtualization manager 150 altering a registered-host of VM 104 in inventory 152 such that VM 104 is registered with the second host 102 or another host where the VM was restarted and is now running. Accordingly, in FIG. 3B, at operation 428, virtualization manager 150 alters a registered-host of VM 104(22) such that the registered-host for VM 104(22) is set to host 102(9) where VM 104(22) is registered and now running.

At operation 430, virtualization manager 150 determines whether VM 104 is running on the second host 102 (e.g., the current associated-host of VM 104). Where, at operation 430, virtualization manager determines that VM 104 is not running on the second host 102, and is instead running on another host 102 in host cluster 110, at operation 432, virtualization manager 150 alters the associated-host of VM 104 in inventory 152 such that VM 104 is associated with the host 102 where the VM 104 is running. In other words, virtualization manager 150 alters the associated-host of VM 104 to be the same as the registered-host for VM 104. Alternatively, where, at operation 430, virtualization manager 150 determines that VM 104 is running on the second host 102 (e.g., its associated-host), operations 400 may be complete (e.g., no further action is necessary to alter the associated-host of VM 104 in inventory 152).

For the example illustrated in FIG. 3B, because the associated-host of VM 104(22) is set to be host 102(9) (e.g., previously set at operation 412) and VM 104(22) is registered and physically running on host 102(9), virtualization manager 150 may not need to take any further action to correct the associated-host of VM 104(22). As such, operations 400 may be complete.

In certain embodiments, as illustrated at operation 424 in FIG. 4, an attempt to restart a VM 104 on a new host 102 (e.g., after a host 102 that the VM was previously running on and associated with is removed) may be unsuccessful. As such, one or more VMs 104 may remain as orphaned VMs within inventory 152. To re-register these VMs 104 on one or more hosts 102 managed by virtualization manager 150, embodiments described herein introduce a recovery service 502. Recovery service 502 may be configured to periodically check for VM objects corresponding to orphaned VMs 104 in inventory 152, and attempt to re-register such identified VMs 104 in inventory 152. Recovery service 502 may run in a software-defined data center (SDDC) infrastructure separate from an SDDC where virtualization manager 150 is deployed, or in the same SDDC where virtualization manager 150 is deployed, such as within virtualization manager 150.

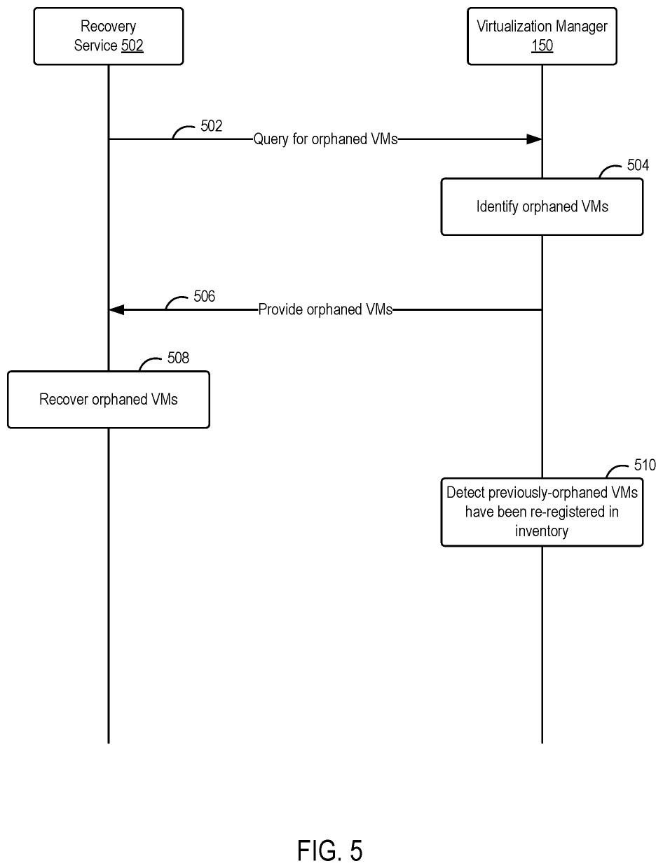

FIG. 5 is a call flow diagram illustrating example operations 500 for recovering orphaned VMs, according to an example embodiment of the present application. Operations 500 may be performed by recovery service 502 and virtualization manager 150 to query for orphaned VMs identified in inventory 152 maintained by virtualization manager 150 such that these orphaned VMs may be re-registered on one or more hosts 102 managed by virtualization manager 150.

Operations 500 begin, at operation 502, by recovery service 502 transmitting a query to virtualization manager 150. The query may be used by recovery service 502 to request a list of orphaned VMs 104 which virtualization manager 150 manages. Recovery service 502 may transmit such query requests periodically and/or in response to receiving a trigger from another component within the SDDC where the recovery service 502 is deployed, such as a trigger from high availability module 156.

In response to receiving the query request, at operation 504, virtualization manager 150 identifies a list of one or more orphaned VMs 104 in inventory 152, such by determining which VMs 104 have an unset registered-host attribute. Further, at operation 506, virtualization manager 150 provides the list of orphaned VMs 104 to recovery service 502. At operation 508, recovery service 502 may attempt to recover (e.g., re-register) each VM 104 identified in the list received from virtualization manager 150.

In cases where one or more of the registration attempts by recovery service 502 are successful, one or more of the previously-orphaned VMs 104 may now be registered in inventory 152. As such, at operation 510, virtualization manager 150 may detect the re-registration of such VMs 104.

In cases where one or more of the registration attempts by recovery service 502 are not successful, these VMs 104 may remain in an orphaned state. As such, recovery of these VMs 104 may not occur until a subsequent query is transmitted by recovery service 502 to virtualization manager 150. In other words, recovery service 502 may continue to attempt to re-register each orphaned VM 104 in inventory 152 until all orphaned VMs 104 are successfully re-registered.

As such, operations 500 are useful to register back any VMs 104 which were not protected or could not be failed over by high availability module 156 (e.g. in operations 400). Further, operations 500 are also useful to help bring back powered off VMs 104 into inventory 152.

It should be understood that, for any workflow described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for tracking virtual machines (VMs) associated with a plurality of hosts in an inventory, the method comprising:
determining to remove a first host of the plurality of hosts, the first host running a first VM, wherein:
the first host and a second host are associated with a first host cluster in the inventory;
the first host is identified as an associated-host of the first VM in the inventory; and
the first host is identified as a registered-host of the first VM in the inventory;
determining the first VM is associated with the first host cluster based on the associated-host of the first VM being the first host and the first host being associated with the first host cluster;
identifying the second host is associated with the first host cluster in the inventory;
altering the associated-host of the first VM such that the second host is the associated-host of the first VM in the inventory;
unsetting the registered-host for the first VM such that the first VM is not registered with any of the plurality of hosts in the inventory; and
removing the first host.

2. The method of claim 1, wherein removing the first host comprises:
removing the first host from a data center where the first host is deployed; and
removing a first host object corresponding to the first host and maintained in the inventory.

3. The method of claim 1, wherein:
a third host is associated with the first host cluster in the inventory; and
the method further comprises, after removing the first host:
detecting that the first VM is not registered with any of the plurality of hosts in the inventory;
identifying the second host and the third host are associated with the first host cluster in the inventory; and
attempting to restart the first VM on the second host or the third host.

4. The method of claim 3, further comprising:
determining that the first VM has been successfully restarted on the second host or the third host; and
in response to determining that the first VM has been successfully restarted, setting the registered-host for the first VM such that the first VM is registered with the second host or the third host in the inventory based on where the first VM is successfully restarted.

5. The method of claim 4, further comprising:
when the first VM is successfully restarted on the third host, determining that the associated-host of the first VM and the registered-host for the first VM are different; and
altering the associated-host of the first VM such that the third host is the associated-host of the first VM in the inventory.

6. The method of claim 3, further comprising:
determining that the first VM has not been successfully restarted on the second host or the third host; and
in response to determining that the first VM has not been successfully restarted, adding the first VM to a list of orphaned VMs in the inventory.

7. The method of claim 6, further comprising:
receiving, from a recovery service, a query requesting the list of orphaned VMs in the inventory;
in response to receiving the query, returning, to the recovery service, the list of orphaned VMs; and
detecting at least the first VM has been recovered and the registered-host of the first VM has been set to the second host or the third host.

8. The method of claim 7, further comprising:
re-registering, by the recovery service, at least the first VM with the second host or the third host based on receiving the list of orphaned VMs.

9. A system comprising:
one or more processors; and
at least one memory, the one or more processors and the at least one memory configured to:
determine to remove a first host of a plurality of hosts in an inventory, the first host running a first VM, wherein:
the first host and a second host are associated with a first host cluster in the inventory;
the first host is identified as an associated-host of the first VM in the inventory; and
the first host is identified as a registered-host of the first VM in the inventory;
determine the first VM is associated with the first host cluster based on the associated-host of the first VM being the first host and the first host being associated with the first host cluster;
identify the second host is associated with the first host cluster in the inventory;
alter the associated-host of the first VM such that the second host is the associated-host of the first VM in the inventory;
unset the registered-host for the first VM such that the first VM is not registered with any of the plurality of hosts in the inventory; and
remove the first host.

10. The system of claim 9, wherein to remove the first host comprises to:
remove the first host from a data center where the first host is deployed; and
remove a first host object corresponding to the first host and maintained in the inventory.

11. The system of claim 9, wherein:
a third host is associated with the first host cluster in the inventory; and
the one or more processors and the at least one memory configured to, after removing the first host:
detect that the first VM is not registered with any of the plurality of hosts in the inventory;
identify the second host and the third host are associated with the first host cluster in the inventory; and
attempt to restart the first VM on the second host or the third host.

12. The system of claim 11, wherein the one or more processors and the at least one memory are further configured to:
determine that the first VM has been successfully restarted on the second host or the third host; and
in response to determining that the first VM has been successfully restarted, set the registered-host for the first VM such that the first VM is registered with the second host or the third host in the inventory based on where the first VM is successfully restarted.

13. The system of claim 12, wherein the one or more processors and the at least one memory are further configured to:
when the first VM is successfully restarted on the third host, determine that the associated-host of the first VM and the registered-host for the first VM are different; and
alter the associated-host of the first VM such that the third host is the associated-host of the first VM in the inventory.

14. The system of claim 11, wherein the one or more processors and the at least one memory are further configured to:
determine that the first VM has not been successfully restarted on the second host or the third host; and
in response to determining that the first VM has not been successfully restarted, add the first VM to a list of orphaned VMs in the inventory.

15. The system of claim 14, wherein the one or more processors and the at least one memory are further configured to:
receive, from a recovery service, a query requesting the list of orphaned VMs in the inventory;
in response to receiving the query, return, to the recovery service, the list of orphaned VMs; and
detect at least the first VM has been recovered and the registered-host of the first VM has been set to the second host or the third host.

16. The system of claim 15, wherein the one or more processors and the at least one memory are further configured to:
re-register, by the recovery service, at least the first VM with the second host or the third host based on receiving the list of orphaned VMs.

17. A non-transitory computer-readable medium comprising instructions that, when executed by one or more processors of a computing system, cause the computing system to perform operations for tracking virtual machines (VMs) associated with a plurality of hosts in an inventory, the operations comprising:
determining to remove a first host of the plurality of hosts, the first host running a first VM, wherein:
the first host and a second host are associated with a first host cluster in the inventory;
the first host is identified as an associated-host of the first VM in the inventory; and
the first host is identified as a registered-host of the first VM in the inventory;
determining the first VM is associated with the first host cluster based on the associated-host of the first VM being the first host and the first host being associated with the first host cluster;
identifying the second host is associated with the first host cluster in the inventory;
altering the associated-host of the first VM such that the second host is the associated-host of the first VM in the inventory;
unsetting the registered-host for the first VM such that the first VM is not registered with any of the plurality of hosts in the inventory; and
removing the first host.

18. The non-transitory computer-readable medium of claim 17, wherein removing the first host comprises:
removing the first host from a data center where the first host is deployed; and
removing a first host object corresponding to the first host and maintained in the inventory.

19. The non-transitory computer-readable medium of claim 17, wherein:
a third host is associated with the first host cluster in the inventory; and
the operations further comprise, after removing the first host:
detecting that the first VM is not registered with any of the plurality of hosts in the inventory;
identifying the second host and the third host are associated with the first host cluster in the inventory; and
attempting to restart the first VM on the second host or the third host.

20. The non-transitory computer-readable medium of claim 19, wherein the operations further comprise:
determining that the first VM has been successfully restarted on the second host or the third host; and
in response to determining that the first VM has been successfully restarted, setting the registered-host for the first VM such that the first VM is registered with the second host or the third host in the inventory based on where the first VM is successfully restarted.
